(19) United States
(12) Patent Application Publication
(10) Pub. No.: US 2016/0350062 A1
(43) Pub. Date: Dec. 1, 2016

(54) REMOTE SCREEN DISPLAY SYSTEM, REMOTE SCREEN DISPLAY METHOD AND NON-TRANSITORY COMPUTER-READABLE RECORDING MEDIUM

(71) Applicant: FUJITSU LIMITED, Kawasaki-shi (JP)

(72) Inventor: Akira KATSUMATA, Oota (JP)

(73) Assignee: FUJITSU LIMITED, Kawasaki-shi (JP)

(21) Appl. No.: 15/166,443

(22) Filed: May 27, 2016

(30) Foreign Application Priority Data
Jun. 1, 2015 (JP) 2015-111553

(51) Int. Cl. G06F 3/14; G09G 5/377; G06F 3/0481; G06T 11/20; G06F 3/0484; H04L 29/06; G09G 5/12

(52) U.S. Cl. CPC G06F 3/1454; H04L 67/42; G09G 5/377; G09G 5/12; G06T 11/20; G06F 3/0484; G06F 3/0481; G09G 2370/022

(57) ABSTRACT

A remote screen display system including a server apparatus and a plurality of client terminal apparatuses, wherein the server apparatus includes a processor configured to transmit a first screen image to each of the plurality of client terminal apparatuses, the first screen image being updated according to processing of a program on the server apparatus, transmit, when an operation for a second screen image has been detected on one of the plurality of client terminal apparatuses, a command to make execute the detected operation to each of other terminal apparatuses different from the one of the plurality of client terminal apparatuses, and wherein each of the plurality of client terminal apparatuses includes a processor configured to generate or update the second screen image based on the command when receiving the command from the server apparatus, display the second screen image that is superimposed on the first screen image.

### CROSS-REFERENCE TO RELATED APPLICATION

This application is based upon and claims the benefit of priority of the prior Japanese Patent Application No. 2015-111553, filed on Jun. 1, 2015, the entire contents of which are incorporated herein by reference.

### FIELD

The embodiments discussed herein are related to a remote screen display system, a remote screen display method and a non-transitory computer-readable recording medium.

### BACKGROUND

In the past, a technology called desktop virtualization has been known. In the technology called the desktop virtualization, a server executes and stores programs or data, and a client terminal device displays, as a remote desktop, an image of a screen transferred by the server. The server executes applications such as, for example, document creation, mails, computer aided design (CAD), and moving images, and the client terminal device displays processing results of the applications based on the server. Here, in order for the client terminal device to display processing results, there are, for example, a method in which the server transfers, to the client terminal device, image information indicating images or compressed image information and a method in which the server transfers, to the client terminal device, commands capable of generating pieces of image information indicating images.

In addition, in the past, there has been known a technology in which a server transmits images, based on a first transmission process, and compresses and transmits images, based on a second transmission process utilizing a compression method different from that of the first transmission process, in a case where an area updated by accumulation of changes between frames of images or the frequency of changes is greater than or equal to a threshold value (see, for example, Japanese Laid-open Patent Publication No. 2012-14533).

In addition, in the past, there has been known a technology for concurrently using screen sharing software and application software together in order to perform an electronic conference, the screen sharing software enabling to browse electronic materials in real time, the application software enabling all members, who participate in the electronic conference, to freely enter characters, drawings, and so forth, which serve as contents of arguments (see, for example, Japanese Laid-open Patent Publication No. 2006-164177).

In addition, in the past, there has been known a technology in which subscriber terminals installed at separated places are interconnected via a communication channel having a function of transmitting pieces of multimedia information such as characters, graphics, images, and sounds, pieces of information such as characters and graphics are displayed on the individual subscriber terminals, and participants work collaboratively while modifying, adding, or deleting pieces of display information (see, for example, Japanese Laid-open Patent Publication No. 4-111151).

In addition, in the past, there has been known a technology for generating graphical user interfaces (GUIs) displayed on a screen of a client device connected to a server device (see, for example, Japanese Laid-open Patent Publication No. 2013-229028). In the technology for generating GUIs, a local GUI including a base image, received from the server device, and a native GUI element is generated.

### SUMMARY

According to an aspect of the invention, a remote screen display system including a server apparatus and a plurality of client terminal apparatuses coupled to the server apparatus respectively, wherein the server apparatus includes a processor configured to transmit a first screen image to each of the plurality of client terminal apparatuses, the first screen image being updated according to processing of a program on the server apparatus and transmit, when receiving information indicating that an operation for a second screen image has been detected on one of the plurality of client terminal apparatuses, a command to make execute the detected operation to each of other terminal apparatuses different from the one of the plurality of client terminal apparatuses, and wherein each of the plurality of client terminal apparatuses includes a processor configured to display the first screen image received from the server apparatus, generate, or update a second screen image based on the command when receiving the command from the server apparatus, display the second screen image that is superimposed on the first screen image and execute, when detecting the operation for the second screen image, the operation for the second screen image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an operation of a remote screen display system;

FIG. 2 is an explanatory diagram illustrating an example of application of the remote screen display system;

FIGS. 3A and 3B are explanatory diagrams each illustrating an example of a system of a VDI system;

FIG. 4 is an explanatory diagram illustrating an example of data reduction of a capture system;

FIG. 5 is an explanatory diagram illustrating examples of screen operations based on users;

FIG. 6 is an explanatory diagram illustrating an example of a hardware configuration of a server;

FIG. 7 is an explanatory diagram illustrating an example of a hardware configuration of a client terminal device;

FIG. 8 is a block diagram illustrating examples of functional configurations of respective devices;

FIG. 9 is an explanatory diagram illustrating an example of a simple operation in a first embodiment;

FIG. 10 is an explanatory diagram illustrating examples of shortcut keys capable of switching between operation layers;

FIG. 11 is an explanatory diagram illustrating an example of an operation information format of a mouse operation or a keyboard operation;

FIG. 12 is an explanatory diagram illustrating an example of a packet format of image information;

FIG. 13 is an explanatory diagram illustrating an example of a packet format of packet information including a drawing command;

FIG. 14A is an explanatory diagram illustrating an example of an operation of a remote screen display system in the first embodiment (a first part);

FIG. 14B is an explanatory diagram illustrating an example of an operation of the remote screen display system in the first embodiment (a second part);

FIG. 14C is an explanatory diagram illustrating an example of an operation of the remote screen display system in the first embodiment (a third part);

FIG. 14D is an explanatory diagram illustrating an example of an operation of the remote screen display system in the first embodiment (a fourth part);

FIG. 14E is an explanatory diagram illustrating an example of an operation of the remote screen display system in the first embodiment (a fifth part);

FIG. 15 is a flowchart illustrating an example of a processing procedure performed by a server according to the first embodiment (a first part);

FIG. 16 is a flowchart illustrating an example of a processing procedure performed by the server according to the first embodiment (a second part);

FIG. 17 is a flowchart illustrating an example of a processing procedure performed by a client terminal device according to the first embodiment;

FIG. 18 is an explanatory diagram illustrating an example of an operation of a remote screen display system in a second embodiment;

FIG. 19 is a flowchart illustrating an example of a processing procedure performed by a server according to the second embodiment (a first part);

FIG. 20 is a flowchart illustrating an example of a processing procedure performed by the server according to the second embodiment (a second part);

FIG. 21 is a flowchart illustrating an example of a processing procedure performed by the server according to the second embodiment (a third part); and

FIG. 22 is a flowchart illustrating an example of a processing procedure performed by a client terminal device according to the second embodiment.

### DESCRIPTION OF EMBODIMENTS

However, in the related art, in order for, for example, persons to work collaboratively, the persons prepare telephone sets or the like available for simultaneous telephone calls, and the persons operate the same screen while making calls. Therefore, there is a problem that a working efficiency is poor.

In one aspect, an object of the present technology is to provide a remote screen display system, a remote screen display method, and a remote screen display program that each enable persons to simultaneously share an image of a screen and an image related to the image of the screen and to efficiently develop a work on the screen.

Hereinafter, a remote screen display system, a remote screen display method, and a remote screen display program, which each serve as an embodiment of the present technology, will be described in detail with reference to accompanying drawings.

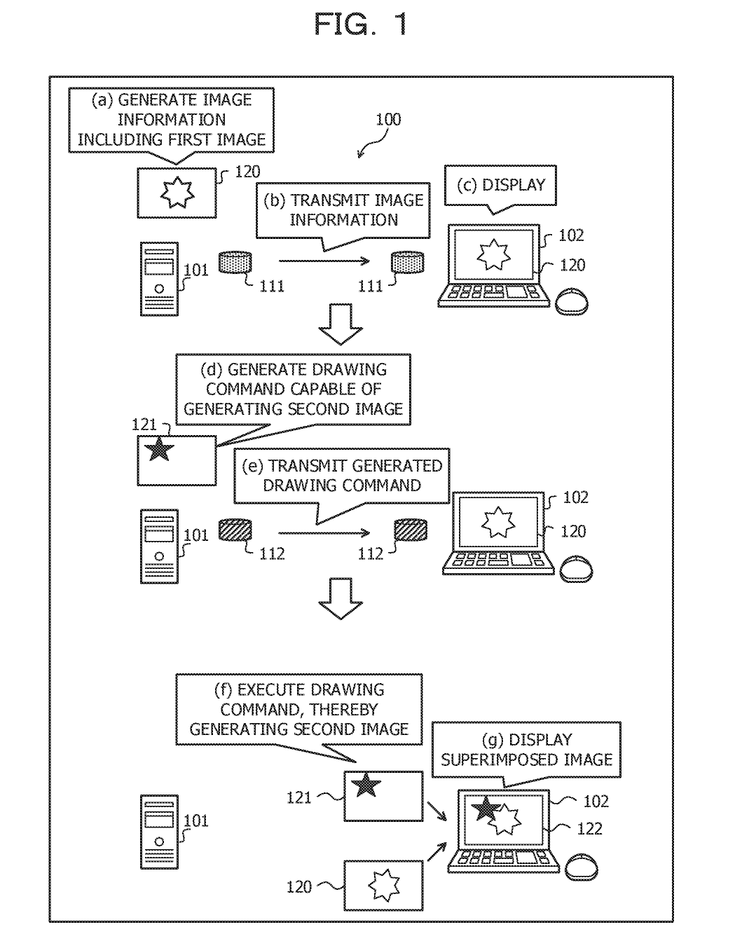

FIG. 1 is an explanatory diagram illustrating an example of an operation of the remote screen display system. A remote screen display system 100 includes, for example, a server 101 and a client terminal device 102. The server 101 and the client terminal device 102 are connected to each other via a network.

The client terminal device 102 causes the server 101 to execute programs. The programs are, for example, various applications.

As described above, in the past, the technology called the desktop virtualization has been known. In the technology called the desktop virtualization, the server 101 executes and stores programs or data, and the client terminal device 102 displays, as a remote desktop, an image of a screen transferred by the server 101. To display, as a remote desktop, an image of a screen, there are transfer technologies called, for example, a capture system and a drawing command system.

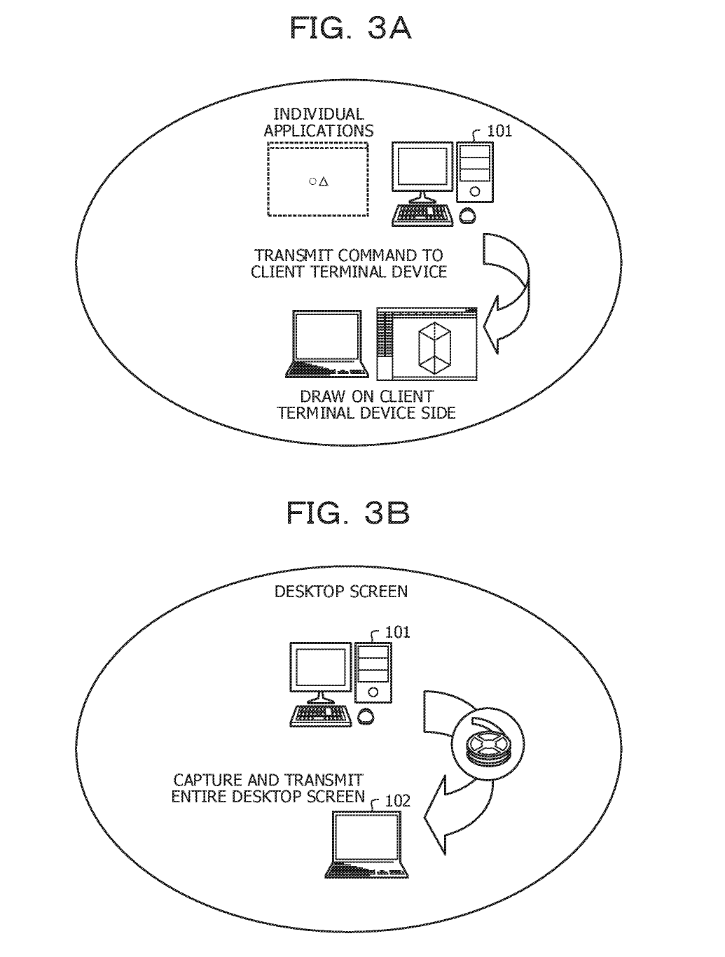

In the capture system, in order for the client terminal device 102 to display a processing result, the server 101 transfers image information, which indicates an image, or compressed image information to the client terminal device 102. In the drawing command system, the server 101 transmits, to the client terminal device 102, a drawing command capable of generating an image. The drawing command is also called a command. The capture system and the drawing command system will be described in detail by using FIGS. 3A and 3B.

In the desktop virtualization technology, in order for, for example, persons to work collaboratively, the persons prepare telephone sets or the like available for simultaneous telephone calls, and the persons operate the same screen while making calls. Therefore, there is a problem that a working efficiency is poor.

In the present embodiment, the server 101 transmits, to a terminal, a command for generating an image related to an image of a display screen, which corresponds to execution of an application, and the relevant terminal displays an image generated by execution of the relevant received command while superimposing the generated image on the image of the relevant screen. From this, the client terminal device shares the image of the screen and the image related to the image of the screen, and a user of the client terminal device is able to efficiently develop a work on the screen.

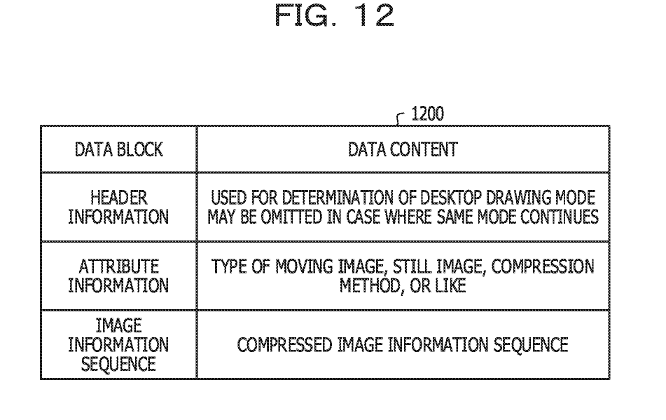

As illustrated in (a) in FIG. 1, the server 101 generates image information 111 including a first image 120 of a screen, which corresponds to execution of a program and which is shared between the client terminal device 102 and the server 101. The image information 111 is a packet including, for example, the first image 120 and information such as metadata. An example of an information format of the image information 111 is illustrated in FIG. 12, described later. While, regarding the information format of the first image 120, a bitmap (BMP), Joint Photographics Experts Group (JPEG), a Graphics Interchange Format (GIF), Portable Network Graphics (PNG), and so forth may be cited, the information format of the first image 120 is not specifically limited.

In addition, as illustrated in (b) in FIG. 1, the server 101 transmits the image information 111 to the client terminal device 102. The first image 120 included in the image information 111 may be compressed information. The client terminal device 102 displays the first image 120 included in the image information 111.

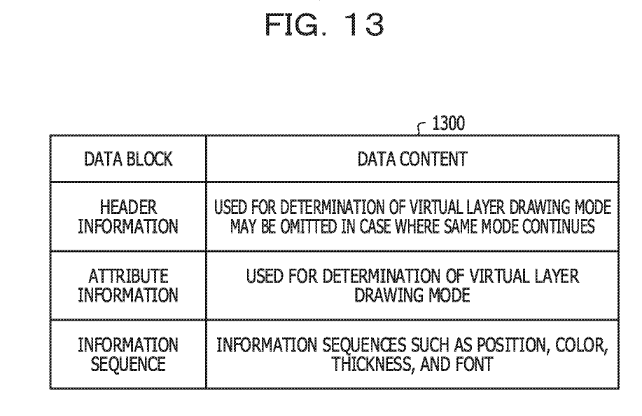

In addition, as illustrated in (d) in FIG. 1, the server 101 generates a drawing command 112. The drawing command 112 is a command that instructs the client terminal device 102 to generate a second image 121. The drawing command 112 includes, for example, information indicating type of drawing target such as a line, a graphic, or a character and pieces of information such as a position, a color, the thickness of a line, and a font. An example of the information format of a packet including the drawing command 112 is illustrated in FIG. 13, described later.

The second image 121 is an image that includes information related to the first image 120 and that is shared with the client terminal device 102. The second image 121 may be, for example, an image including information obtained by an operation performed by a user on the client terminal device 102 in response to the first image 120 displayed on the client terminal device 102. The information obtained by an operation is input information of, for example, a line, a graphic, a character, and so forth. The image including the information obtained by an operation is, for example, an image in which the information obtained by an operation is converted into a display format. In addition, the second image 121 may be an image including information of a chat input by the user in response to the first image 120. The information of a chat is, for example, character codes of the chat input by the user. The image including the information of the chat is, for example, an image in which the information of the chat is converted into a display format.

In addition, the second image 121 may be, for example, an image including information generated based on a character string obtained from the first image 120. As the character string obtained from the first image 120, a character string or the like obtained from the first image 120 by using, for example, optical character recognition (OCR) may be cited. The information generated based on the character string is, for example, a semantic content of words obtained by the OCR. The image including the information generated based on the character string is, for example, an image in which the semantic content of words is converted into a display format. In addition, the second image 121 may be an image according to design related to the first image 120. As the design, design or the like utilizing, for example, the CAD or the like may be cited. The image according to the design is, for example, an image in which an article, which serves as a design target and which is arranged in a simulation space set on a computer, is converted into a display format.

In addition, while, regarding the information format of the second image 121, files in BMP, JPEG, GIF, and PNG formats and so forth may be cited, the information format of the second image 121 is not specifically limited. As illustrated in (e) in FIG. 1, the server 101 transmits the generated drawing command 112 to the client terminal device 102.

As illustrated in (f) in FIG. 1, the client terminal device 102 generates the second image 121 by executing the received drawing command 112. In addition, as illustrated in (g) in FIG. 1, each of the client terminal devices 102 displays an image 122 in which the generated second image 121 is superimposed on the first image 120 included in the received image information 111. Superimposing the second image 121 on the first image 120 means that depths of the respective images are set so that the first image 120 is located behind, for example, the second image 121 in a case where the user looks at a display serving as a display target.

In this way, with a small data amount utilizing the command system, it is possible to perform exchanges between the server 101 and the client terminal device 102. Specifically, it is possible to cause the second image 121, which corresponds to an operation received by, for example, one of the client terminal devices 102, to be swiftly displayed by another one of the client terminal devices 102. From this, it is possible for users to exchange communication related to an image of a screen, not via other devices such as telephone sets. In addition, it is possible to perform exchanges between the server 101 and the client terminal device 102 with a small data amount. Therefore, in a case of performing the relevant communication by using telephone sets or the like together, it is possible to smoothly perform the relevant communication. Accordingly, it is possible for users of the client terminal devices 102 to efficiently develop works on screens.

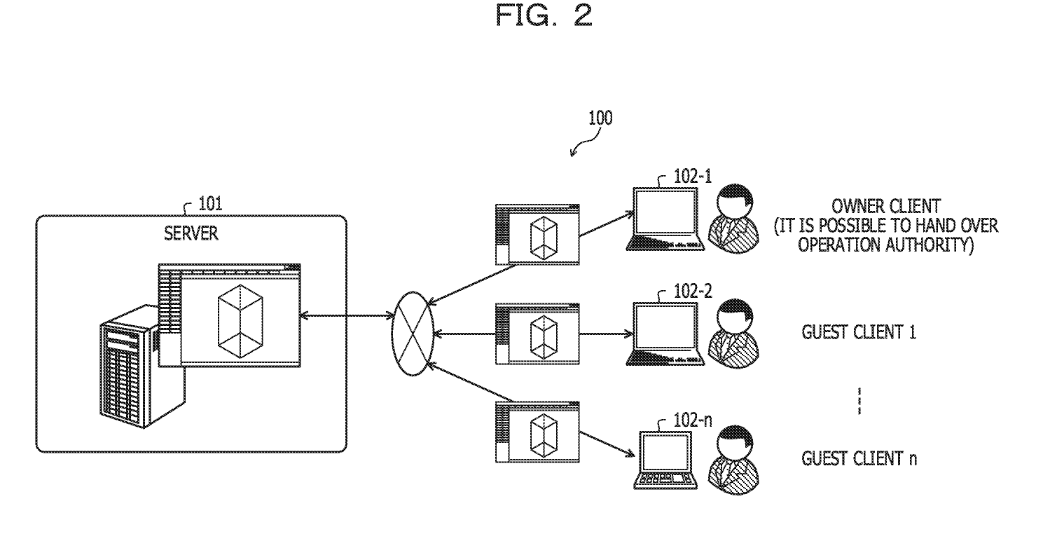

FIG. 2 is an explanatory diagram illustrating an example of application of the remote screen display system. Here, the remote screen display system 100 is an example in which users operate the CAD. The remote screen display system 100 includes, for example, the server 101 and the client terminal devices 102. The server 101 and the client terminal devices 102 are connected to one another via a network. As the network, regardless of wired and wireless connections, arbitrary types of communication network such as the Internet, a local area network (LAN), a wide area network (WAN), and a virtual private network (VPN) may be adopted. The client terminal devices 102 each execute a program by using the server 101. As examples of the client terminal devices 102, in addition to fixed terminal devices such as PCs, mobile terminal devices such as a mobile phone, a PHS, and a PDA may be cited. The client terminal devices 102 include an owner client terminal device 102-1 and guest client terminal devices 102-2 to 102-n. The owner client terminal device 102-1 is able to hand over, to, for example, the guest client terminal devices 102-2 to 102-n, operation authority related to a program executed by the server 101. By receiving the operation authority from the owner client terminal device 102-1, each of the guest client terminal devices 102-2 to 102-n is able to perform an operation related to execution of the program.

In addition, as the program, an application related to a business operation such as document creation or mailing, an application such as the CAD which handles images, an application which handles moving images, or the like may be cited. In the example of FIG. 2, the program is the CAD, and the server 101 and the client terminal devices 102 each display the same screen of the CAD.

In addition, since a method for delivery and receipt of the operation authority or the like is known, a detailed description thereof will be omitted in the present embodiment.

FIGS. 3A and 3B are explanatory diagrams each illustrating an example of a system of a VDI system. The virtual desktop infrastructure (VDI) system includes, for example, a drawing command system illustrated in FIG. 3A and a capture system illustrated in FIG. 3B.

As illustrated in FIG. 3A, in the drawing command system, the server 101 transmits, to the client terminal device 102, a command that instructs to generate an image of a screen, which corresponds to execution of a program such as an application. By executing the received command, the client terminal device 102 generates the image of the screen. In addition, the client terminal device 102 displays the generated image. The drawing command system is suitable for a line drawing and so forth. However, in a case of a moving image, a response is reduced in some cases.

As illustrated in FIG. 3B, in the capture system, the server 101 generates and transmits, to the client terminal devices 102, image information including an image of a screen. In addition, the client terminal devices 102 each display the image included in the received image information. More specifically, the server 101 transmits, to the client terminal devices 102, the image information including, for example, a compressed image. By decompressing the compressed image included in the image information, the client terminal devices 102 each display the image included in the image information.

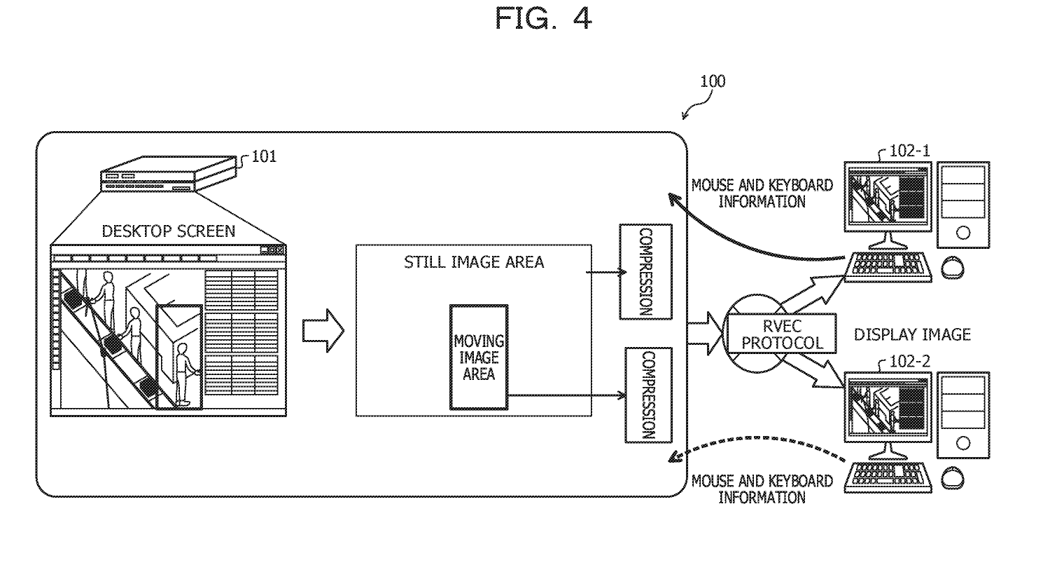

In the capture system, while a data amount is large, it is possible to transmit, to the client terminal devices 102, image information included in an image of the screen without dependence on applications. Therefore, the present embodiment is based on the premise of using the capture system. In addition, an example of reducing a transmitted data amount is illustrated in FIG. 4.

FIG. 4 is an explanatory diagram illustrating an example of data reduction of the capture system. By investigating a difference between screens at regular time intervals, the server 101 estimates a moving image area in which an update is frequently performed within the screen. In addition, the server 101 partially defines the estimated moving image area as a moving image. Next, the server 101 performs conversion into packets including a compressed still image and a compressed moving image and transmits the packets to the client terminal devices 102.

In addition, the client terminal devices 102 may each expand and combine the compressed still image and the compressed moving image, thereby displaying the image of the screen. In this way, it is possible to achieve reduction of the transmitted data amount. The still image is based on a format such as, for example, PNG or CAD image compression, and moving image information is based on a format such as, for example, Moving Picture Experts Group (MPEG) or H.264.

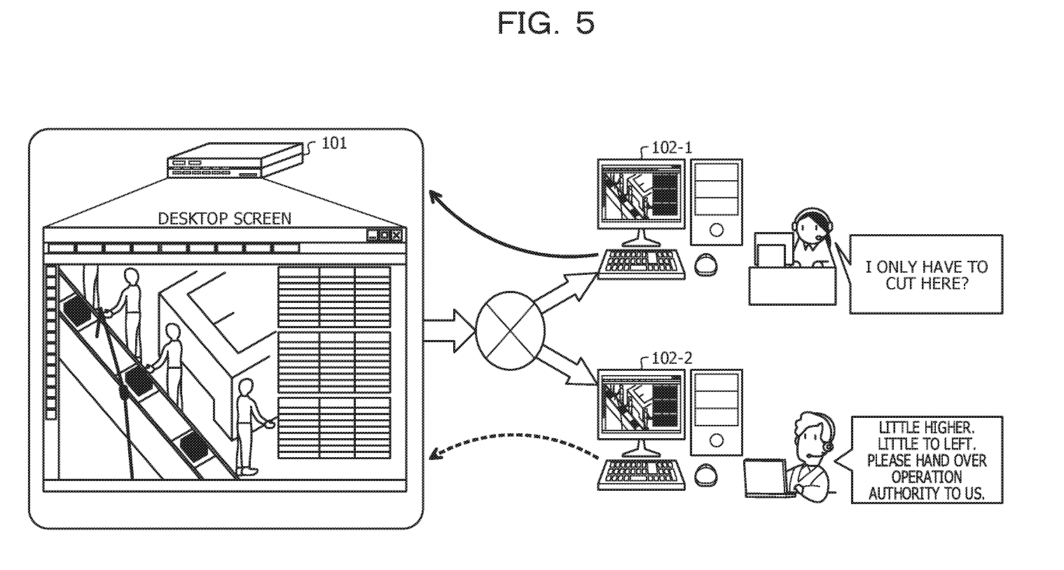

FIG. 5 is an explanatory diagram illustrating examples of screen operations based on users. In a case of using the capture system, an image displayed on a display of each of the client terminal devices 102 is exactly the same as the image of the screen included in the server 101. In order for users to work collaboratively, the users prepare telephone sets or the like available for, for example, simultaneous telephone calls and perform the collaborative work while having conversations via the telephone sets.

Therefore, in a case of performing, as illustrated in FIG. 5, operations while having conversations via the telephone sets, there is, for example, a problem that it is difficult to point out a specific position or the like. It is desirable that one of the users operates a screen while users smoothly communicate with one another. As described above, in the present embodiment, it is possible to establish, not via telephone sets or the like, communication related to an image of a screen.

Example of Hardware Configuration of Server 101

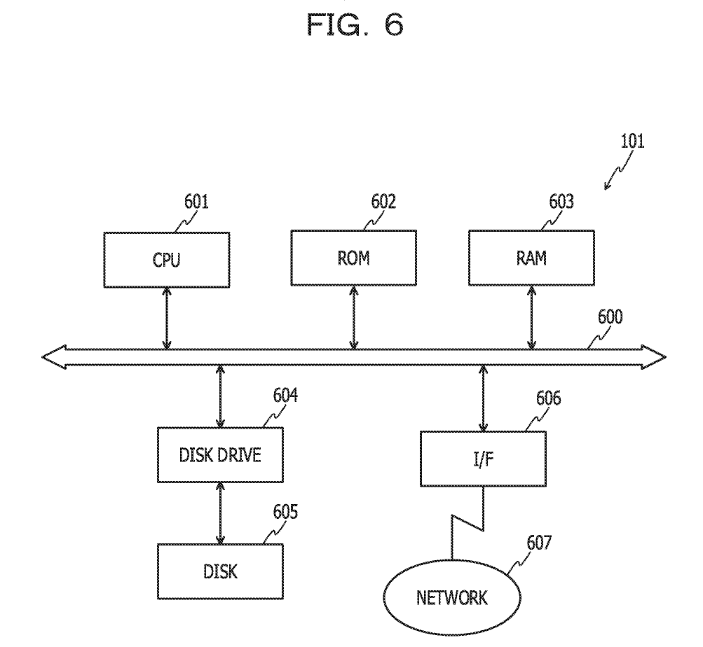

FIG. 6 is an explanatory diagram illustrating an example of a hardware configuration of a server. The server 101 includes a central processing unit (CPU) 601, a read only memory (ROM) 602, a random access memory (RAM) 603, a disk drive 604, a disk 605, and an inter/face (I/F) 606.

The CPU 601, the ROM 602, the RAM 603, the disk drive 604, and the I/F 606 are connected to one another via a bus 600.

Here, the CPU 601 manages overall control of the server 101 and so forth. The read only memory (ROM) 602 stores therein various programs. The programs stored in the ROM 602 are loaded into the CPU 601, thereby causing the CPU 601 to perform coded processing operations. The RAM 603 is used as a work area of the CPU 601.

The I/F 606 is connected to a network 607 via a communication line and is connected to other devices via the network 607. In addition, the I/F 606 controls an interface between the network 607 and the interior and controls input and output of data from and to another computer. As the I/F 606, for example, a modem, a LAN adapter, or the like may be adopted.

In accordance with control from the CPU 601, the disk drive 604 controls read and write of data from and to the disk 605. The disk 605 stores therein data written based on control from the disk drive 604. As the disk 605, for example, a magnetic disk, a, optical disk, or the like may be cited.

In addition, in addition to the above-mentioned configuration units, the server 101 may include, for example, a solid state drive (SSD), a keyboard, a mouse, a display, and so forth.

Example of Hardware Configuration of Client Terminal Device 102

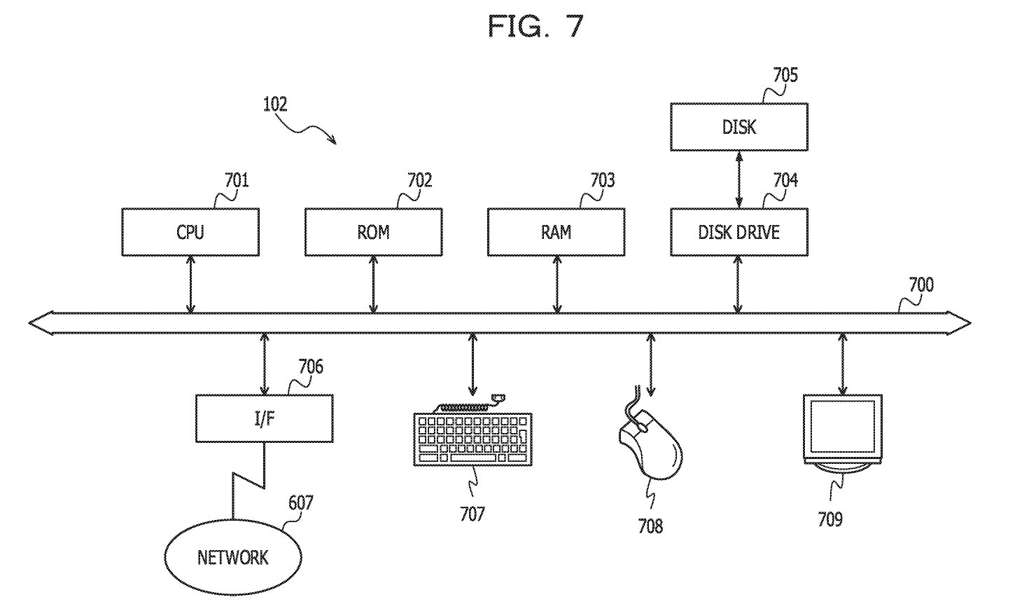

FIG. 7 is an explanatory diagram illustrating an example of a hardware configuration of a client terminal device. The client terminal devices 102 each include a CPU 701, a ROM 702, a RAM 703, a disk drive 704, and a disk 705. The client terminal devices 102 each include an I/F 706, a keyboard 707, a mouse 708, and a display 709. In addition, the CPU 701, the ROM 702, the RAM 703, the disk drive 704, the I/F 706, the keyboard 707, the mouse 708, and the display 709 are connected to one another via a bus 700.

Here, the CPU 701 manages overall control of the corresponding client terminal device 102. The ROM 702 stores therein programs such as a boot program. The RAM 703 is used as a work area of the CPU 701. In accordance with control from the CPU 701, the disk drive 704 controls read and write of data from and to the disk 705. The disk 705 stores therein data written based on control from the disk drive 704. As the disk 705, for example, a magnetic disk, a, optical disk, or the like may be cited.

The I/F 706 is connected to the network 607 such as a LAN, a WAN or the Internet via a communication line and is connected to other devices via the network 607. In addition, the I/F 706 controls an interface between the network 607 and the interior and controls input and output of data from and to an external device. As the I/F 706, for example, a modem, a LAN adapter, or the like may be adopted.

Each of the keyboard 707 and the mouse 708 is an interface that inputs various kinds of data, based on an operation of a user. The display 709 is an interface that outputs data, based on an instruction of the CPU 701.

In addition, while illustration is omitted, an input device, which imports images and moving images from a camera, and an input device, which imports sounds from a microphone, may be provided in each of the client terminal devices 102. In addition, while illustration is omitted, an output device such as a printer may be provided in each of the client terminal devices 102.

Examples of Functional Configurations of Respective Devices

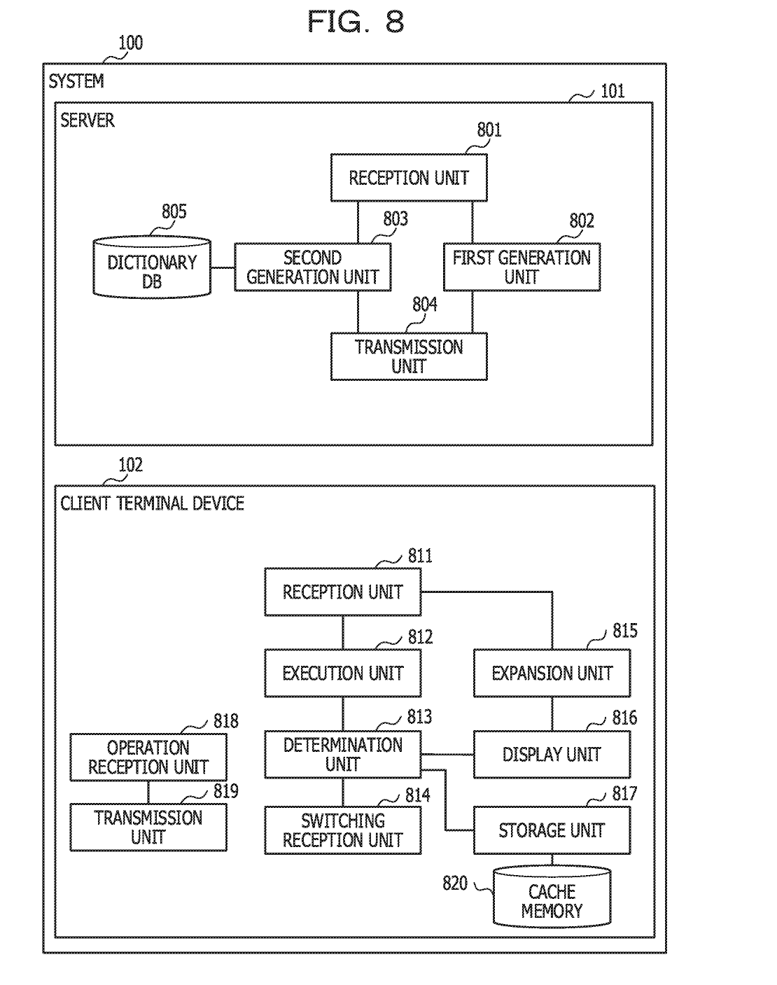

FIG. 8 is a block diagram illustrating examples of functional configurations of respective devices. The server 101 includes a reception unit 801, a first generation unit 802, a second generation unit 803, a transmission unit 804, and a dictionary DB 805. Processing operations of control units of the reception unit 801 to the transmission unit 804 are coded into programs stored in a storage device such as, for example, the ROM 602, the RAM 603, or the disk 605, accessible by the CPU 601 and illustrated in FIG. 6. In addition, the CPU 601 reads the relevant programs from the storage device and performs the processing operations coded into the programs. From this, the processing operations of the respective control units are realized. In addition, processing results of the respective units in the server 101 are stored in a storage device such as, for example, the ROM 602, the RAM 603, or the disk 605.

The client terminal devices 102 each include a reception unit 811, an execution unit 812, a determination unit 813, a switching reception unit 814, an expansion unit 815, a display unit 816, a storage unit 817, an operation reception unit 818, a transmission unit 819, and a cache memory 820. Processing operations of control units of the reception unit 811 to the transmission unit 819 are coded into programs stored in a storage device such as, for example, the ROM 702, the RAM 703, or the disk 705, accessible by the CPU 701 and illustrated in FIG. 7. In addition, the CPU 701 reads the relevant programs from the storage device and performs the processing operations coded into the programs. From this, the processing operations of the respective control units are realized. In addition, processing results of the respective units in each of the client terminal devices 102 are stored in a storage device such as, for example, the RAM 703, the ROM 702, or the disk 705.

The individual units illustrated in FIG. 8 will be described using a first embodiment and a second embodiment. In the first embodiment, in a collaboration work based on the client terminal devices 102, the second image 121 is superimposed on the first image 120 and displayed, the second image 121 including information obtained by an operation performed by a user on one of the client terminal devices 102 in response to the first image 120 displayed on a screen. In the second embodiment, the second image 121 is superimposed on the first image 120 and displayed, the second image 121 including information, related to a character string obtained from the first image 120 displayed on a screen.

### First Embodiment

In the first embodiment, in the collaboration work based on the client terminal devices 102, the second image 121 is superimposed on the first image 120 and displayed, the second image 121 including information obtained by an operation performed by a user on one of the client terminal devices 102 in response to the first image 120 displayed on a screen.

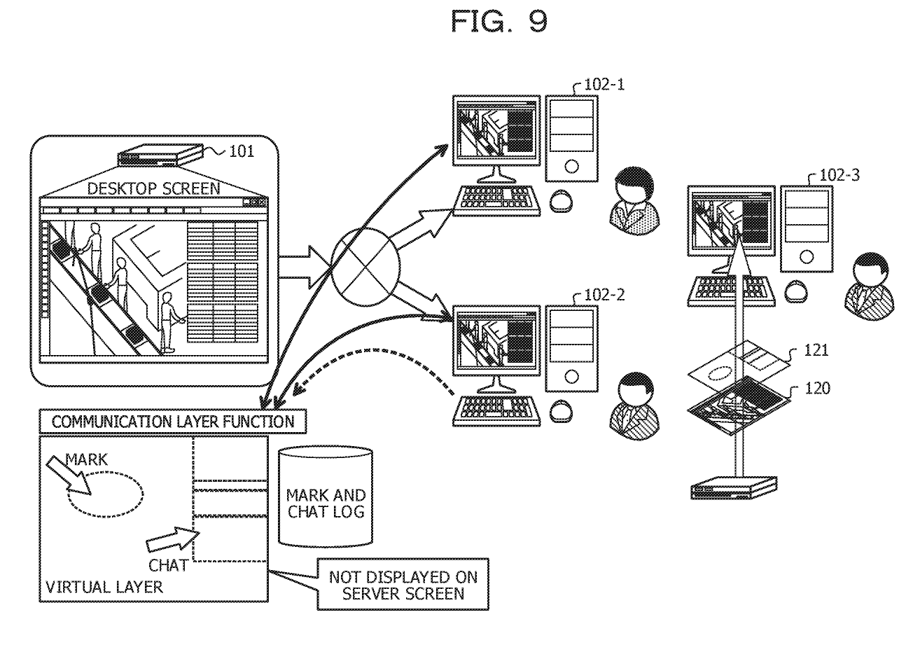

FIG. 9 is an explanatory diagram illustrating an example of a simple operation in the first embodiment. The server 101 transmits, to each of the client terminal devices 102, the image information 111 including the first image 120 of a desktop screen. The client terminal devices 102 each display the first image 120 included in the received image information 111.

In addition, regarding the first image 120, the client terminal device 102-2 transmits, to the server 101, pieces of operation information such as a display instruction for a mark and a display instruction for a text such as a chat. In addition, the server 101 generates a command capable of generating the second image 121 corresponding to an operation of the client terminal device 102-2, indicated by the received operation information. The server 101 transmits the generated command to each of the client terminal devices 102.

Next, the client terminal devices 102 each execute the received command and generates the second image 121. In addition, the client terminal devices 102 each display, on the display 709, an image in which the generated second image 121 is superimposed on the first image 120 included in the image information 111.

The switching reception unit 814 receives information indicating switching between operation layers. The operation layers include, for example, a virtual layer operation and a desktop operation. The desktop operation is an operation related to an application executed by the server 101. The virtual layer operation is an operation related to an image corresponding to an image of a screen of execution of an application. In addition, as the virtual layer operation, there are, for example, a marking input and a chat input. The marking input is a function capable of inputting a mark such as an arrow, as illustrated in FIG. 9. The chat input is a function capable of inputting a character string of a chat, such as a text, as illustrated in FIG. 9.

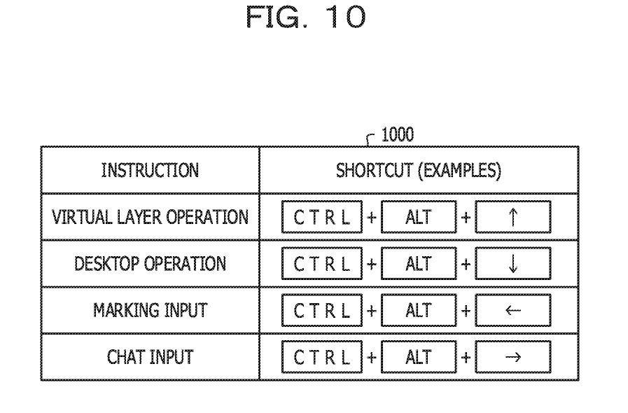

FIG. 10 is an explanatory diagram illustrating examples of shortcut keys capable of switching between operation layers. A table 1000 indicates keys pressed in order to cause the corresponding client terminal device 102 to perform individual operations. As the operations, the virtual layer operation, the desktop operation, the marking input, the chat input, and so forth may be cited. After inputting a shortcut key, thereby changing an operation mode, a corresponding user becomes able to perform various kinds of input.

In order to switch to a state of, for example, the virtual layer operation, the user simultaneously inputs “CTRL”, “ALT”, and “↑”. In order for the user to switch to a state of, for example, the desktop operation, “CTRL”, “ALT”, and “↓” are simultaneously input. In order to switch to a state of, for example, the marking input, the user simultaneously inputs “CTRL”, “ALT”, and “←”. In order to switch to a state of, for example, the chat input, the user simultaneously inputs “CTRL”, “ALT”, and “→”.

Returning to the description of FIG. 8, the switching reception unit 814 receives information indicating the presence or absence of display of the virtual layer. The information indicating the presence or absence of display is stored, as the latest information, in a storage device such as the ROM 702, the RAM 703, or the disk 705. Based on the information indicating the presence or absence of display, the determination unit 813, described later, performs determination. The information indicating the presence or absence of display is received via, for example, various kinds of input device such as the keyboard 707 and the mouse 708. A shortcut key may be assigned to the information indicating the presence or absence of display, and an input format thereof is not specifically limited.

The operation reception unit 818 receives various kinds of operation information via various kinds of input device such as the keyboard 707 and the mouse 708. Specifically, the operation reception unit 818 receives, as the operation information, for example, right and left clicks, a double click, and a drag of the mouse 708, and the position and the movement amount of a mouse cursor, obtained via the movement operation of the mouse 708.

The transmission unit 819 transmits the operation information in accordance with a current state. The current state is expressed by, for example, the operation layer.

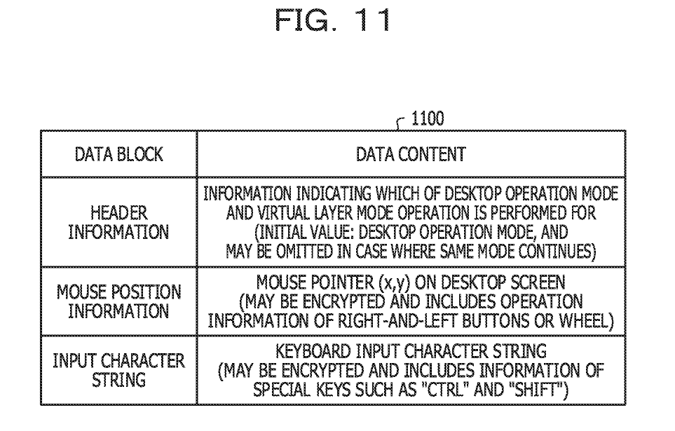

FIG. 11 is an explanatory diagram illustrating an example of an operation information format of a mouse operation or a keyboard operation. Operation information 1100 includes, for example, header information, mouse position information, and an input character string. The header information includes information indicating, for example, which of the desktop operation mode and the virtual layer mode an operation is performed for. In this regard, however, in a case where each of the operation modes continues, the header information may be omitted.

The mouse position information includes information of, for example, an x-axis coordinate value and a y-axis coordinate value of a mouse pointer on the desktop screen. In addition, the mouse position information includes hold-down information of right and left buttons, operation information of a wheel, and so forth. Actually, the mouse position information is encrypted.

The input character string includes an input character string input by, for example, the keyboard 707. The input character string includes input information of special keys such as “CTRL” and “SHIFT”.

The reception unit 801 receives the operation information from the corresponding client terminal device 102. In a case where the header information included in the received operation information indicates the desktop operation mode, the first generation unit 802 generates the image information 111 including the first image 120 of a screen, which corresponds to an operation indicated by the operation information. The transmission unit 804 transmits the image information 111 to the corresponding client terminal device 102. The image information 111 is, for example, packet information and includes the first image 120 and metadata such as a header.

FIG. 12 is an explanatory diagram illustrating an example of a packet format of image information. Packet information 1200 is a detailed example of the image information 111. The packet information 1200 includes, for example, header information, attribute information, and an image information sequence. The header information includes identification information indicating being in the desktop drawing mode. The header information may be omitted in a case where the desktop drawing mode continues.

The attribute information is the type of moving image, still image, compression method, or the like. The image information sequence includes a compressed image information sequence.

In addition, in a case where the header information included in the received operation information indicates the virtual layer drawing mode, the second generation unit 803 generates a drawing command capable of generating the second image 121 corresponding to an operation indicated by the operation information. In addition, the transmission unit 804 transmits the generated drawing command to, for example, the corresponding client terminal device 102. More specifically, the transmission unit 804 transmits, to, for example, the corresponding client terminal device 102, the packet information including the generated drawing command.

FIG. 13 is an explanatory diagram illustrating an example of a packet format of packet information including a drawing command. Packet information 1300 is the packet information including a drawing command. The packet information 1300 includes header information, attribute information, and an information sequence. The header information includes identification information indicating being in the virtual layer drawing mode. In a case where the virtual layer drawing mode continues, the header information may be omitted.

The attribute information and the information sequence correspond to the drawing command. The attribute information includes identification information indicating the type of, for example, line, graphic, character, or the like. The information sequence includes information sequences such as, for example, a position, a color, a thickness, and a font. A content of the information sequence is a content set for a drawing target indicated by the identification information set in the attribute information. An example of the packet information in a case of causing a line of blue color to be drawn from a starting point (0,0) to an ending point (100,100) in a screen will be cited. The header information includes the identification information indicating, for example, the virtual layer drawing mode, and the attribute information includes the identification information indicating, for example, a “line”. In addition, the information sequence includes starting point position information indicating, for example, the starting point (0,0), ending point position information indicating, for example, the ending point (100,100), and color information indicating the “blue color”.

Next, the reception unit 811 receives the image information 111. In a case where the first image 120 is compressed information, the expansion unit 815 expands, for example, the first image 120 included in the image information 111. In addition, the display unit 816 displays the first image 120 expanded by the expansion unit 815.

In addition, the reception unit 811 receives the drawing command. By executing the received drawing command, the execution unit 812 generates the second image 121.

In addition, by using the switching reception unit 814, the determination unit 813 determines the presence or absence of display, based on the information indicating the presence or absence of display of the second image 121. In a case where it is determined that the information indicating the presence or absence of display of the second image 121 indicates the absence thereof, the storage unit 817 stores the second image 121 in the cache memory 820.

In a case where it is determined that the information indicating the presence or absence of display of the second image 121 indicates the presence thereof, the display unit 816 displays an image in which the second image 121 is superimposed on the first image 120. Specifically, by setting depths of the respective images so that the first image 120 is located behind, for example, the second image 121 in a case where a user looks at the display 709, the display unit 816 displays the images.

In addition, the switching reception unit 814 receives the presence or absence of display of the second image 121. In addition, in a case where the presence or absence of display of the first image 121 changes from the absence to the presence, the display unit 816 displays an image in which the second image 121 stored in the cache memory 820 is superimposed on the first image 120. In addition, the display unit 816 deletes the second image 121 from the cache memory 820.

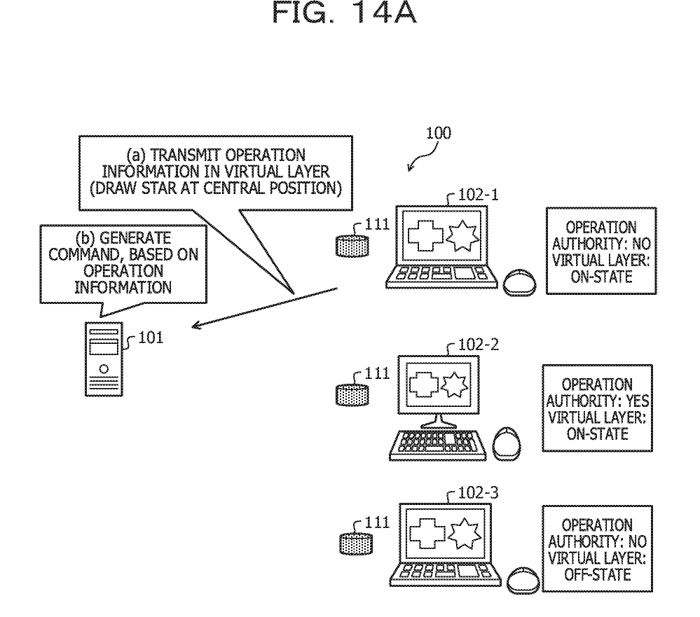

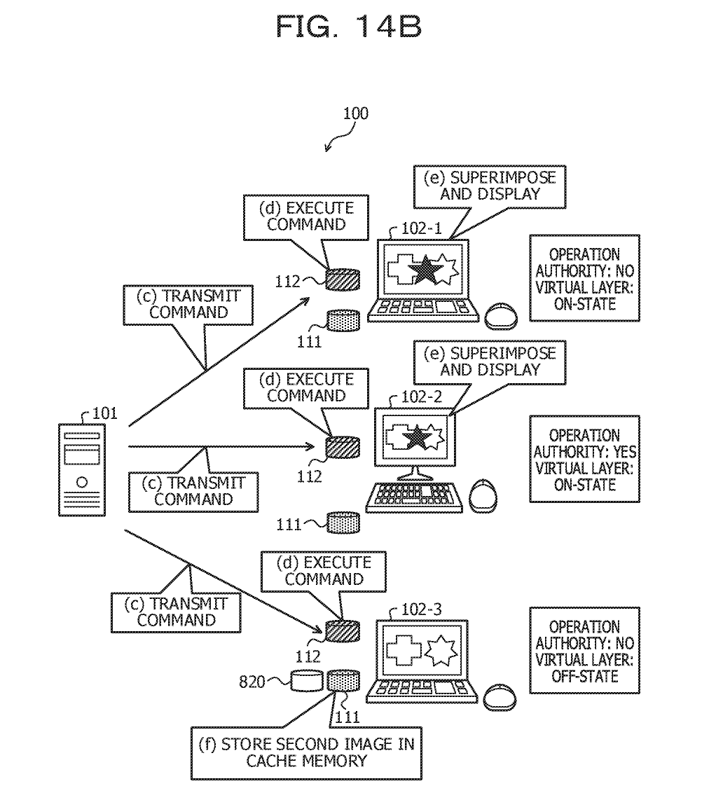

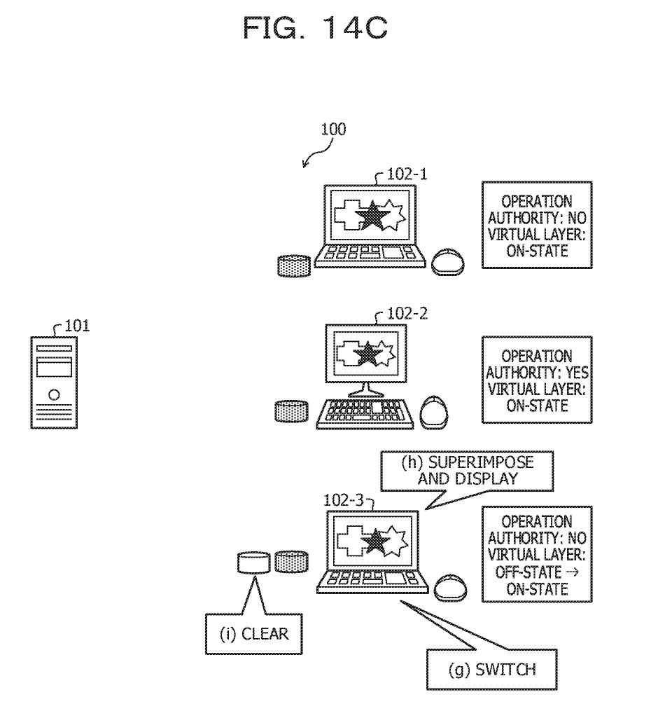

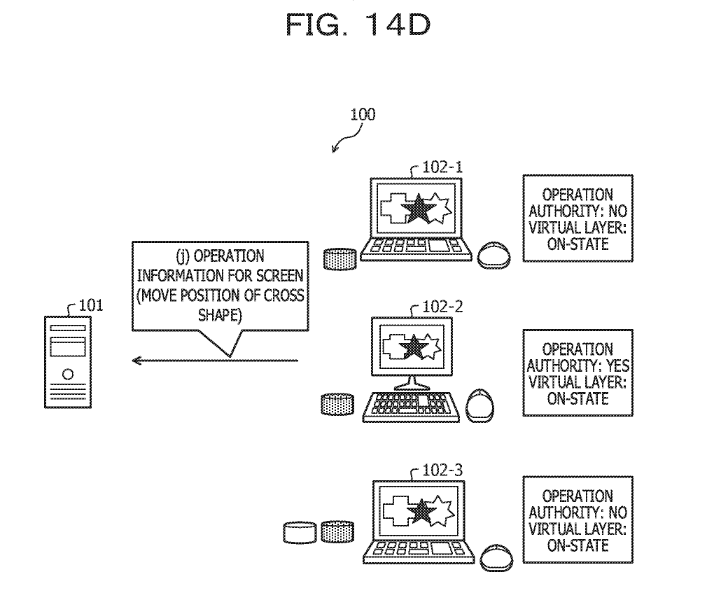

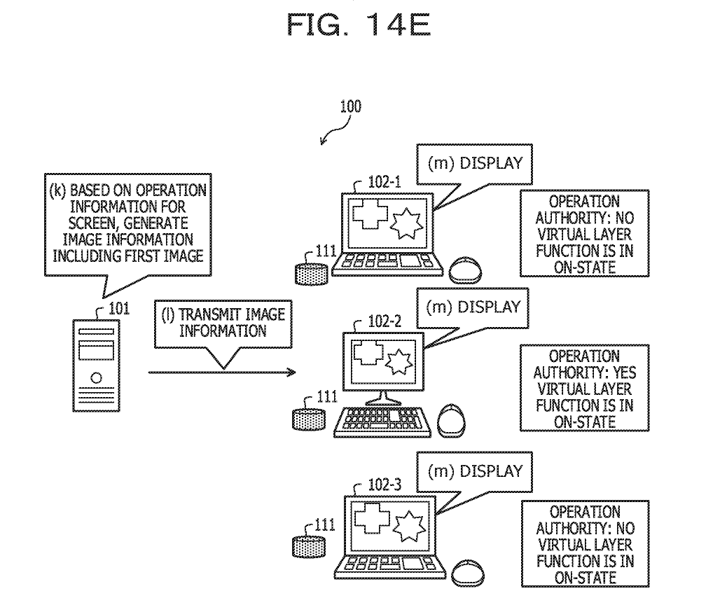

FIGS. 14A to 14E are explanatory diagrams each illustrating an example of an operation of a remote screen display system in the first embodiment. As illustrated in (a) in FIG. 14A, the client terminal device 102-1 transmits, to the server 101, operation information intended to write a star at a central position. As illustrated in (b) in FIG. 14A, upon receiving the operation information, the server 101 generates a command that instructs to write the star at the central position.

As illustrated in (c) in FIG. 14B, the server 101 transmits the generated command to each of the client terminal devices 102. As illustrated in (d) in FIG. 14B, each of the client terminal devices 102 executes the command, thereby generating the second image 121.

As illustrated in (e) in FIG. 14B, since the virtual layer functions are in on-states, the client terminal device 102-1 and the client terminal device 102-2 each display an image in which the generated second image 121 is superimposed on the first image 120. On the other hand, as illustrated in (f) in FIG. 14B, since the virtual layer function is in an off-state, the client terminal device 102-3 stores the generated second image 121 in the cache memory 820.

In addition, as illustrated in (g) in FIG. 14C, the client terminal device 102-3 receives switching the virtual layer function from the off-state to the on-state. In addition, as illustrated in (h) in FIG. 14C, the client terminal device 102-3 displays an image in which the second image 121 stored in the cache memory 820 is superimposed on the first image 120. In addition, as illustrated in (i) in FIG. 14C, the client terminal device 102-3 clears the cache memory 820.

As illustrated in (j) in FIG. 14D, since having operation authority, the client terminal device 102-2 transmits operation information for a screen, which indicates that a position of a cross shape of is to be moved.

As illustrated in (k) in FIG. 14E, based on the received operation information for the screen, the server 101 generates the image information 111 including the first image 120 of the screen. In addition, as illustrated in (I) in FIG. 14E, the server 101 transmits the image information 111 to each of the client terminal devices 102. Next, as illustrated in (m) in FIG. 14E, the client terminal devices 102 each display the received image information 111.

In addition, in the example of FIG. 14E, each of the client terminal devices 102 does not store the second image 121 serving as an execution result of a previously received command. Therefore, each of the client terminal devices 102 displays the first image 120 while not superimposing the latest second image 121 thereon. In addition, in order to superimpose the latest second image 121, the server 101 may store therein a generated command, and after transmitting the new first image 120, the server 101 may transmit a latest command to the corresponding client terminal devices 102.

Example of Processing Procedure Performed by Server 101 According to First Embodiment

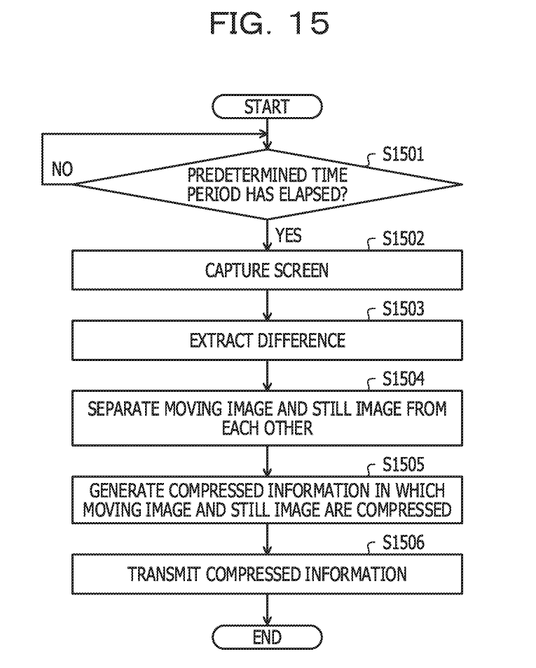

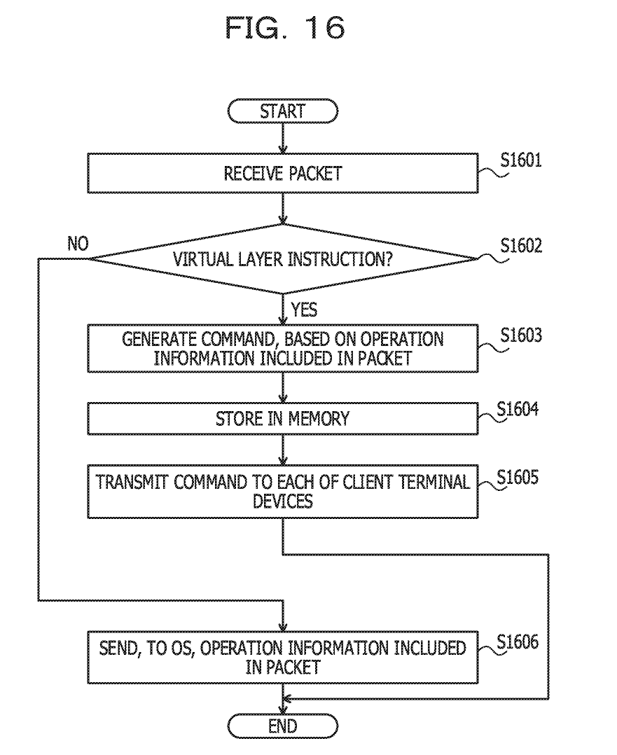

FIG. 15 and FIG. 16 are flowcharts each illustrating an example of a processing procedure performed by a server according to the first embodiment. Here, in the server 101, an OS currently executes a program such as some kind of application. Using FIG. 15, an example of a processing procedure by which the server 101 transmits the first image 120 will be described. In addition, using FIG. 16, an example of a processing procedure by which the server 101 transmits a command for generating the second image 121 will be described.

First, the server 101 determines whether or not a predetermined time period has elapsed (step S1501). In a case where it is determined that the predetermined time period has not elapsed (step S1501: No), the server 101 returns to step S1501. In a case where it is determined that the predetermined time period has elapsed (step S1501: Yes), the server 101 captures a screen (step S1502). The “capture” means recording, as information of an image, a signal for display.

The server 101 extracts a difference between the currently captured screen and a previously captured screen (step S1503). In addition, based on the difference, the server 101 separates a moving image and a still image from each other (step S1504). The server 101 generates compressed information in which the moving image and the still image are compressed (step S1505). The server 101 transmits the compressed information (step S1506) and terminates a series of processing operations. Here, in step S1506, specifically, the server 101 transmits packet information including the compressed information.

Proceeding to the description of FIG. 16, the server 101 receives a packet (step S1601). In addition, the server 101 determines whether or not being a virtual layer instruction (step S1602). In a case of being determined as being the virtual layer instruction (step S1602: Yes), the server 101 generates a command, based on operation information included in the packet (step S1603). In addition, the server 101 stores the generated command in a memory (step S1604). The memory is, for example, the RAM 603, the disk 605, or the like.

The server 101 transmits the generated command to each of the client terminal devices 102 (step S1605) and terminates a series of processing operations. Here, to generate a command, the server 101 may generate a new command including the command stored in the memory. In addition, the server 101 may delete the command stored in the memory, in response to an instruction of a user, and may delete, in a specific unit of time, the command stored in the memory.

On the other hand, in a case of, in step S1602, being determined as not being the virtual layer instruction (step S1602: No), the server 101 sends, to the OS, the operation information included in the packet (step S1606) and terminates a series of processing operations.

Example of Processing Procedure Performed by Client Terminal Device 102 According to First Embodiment

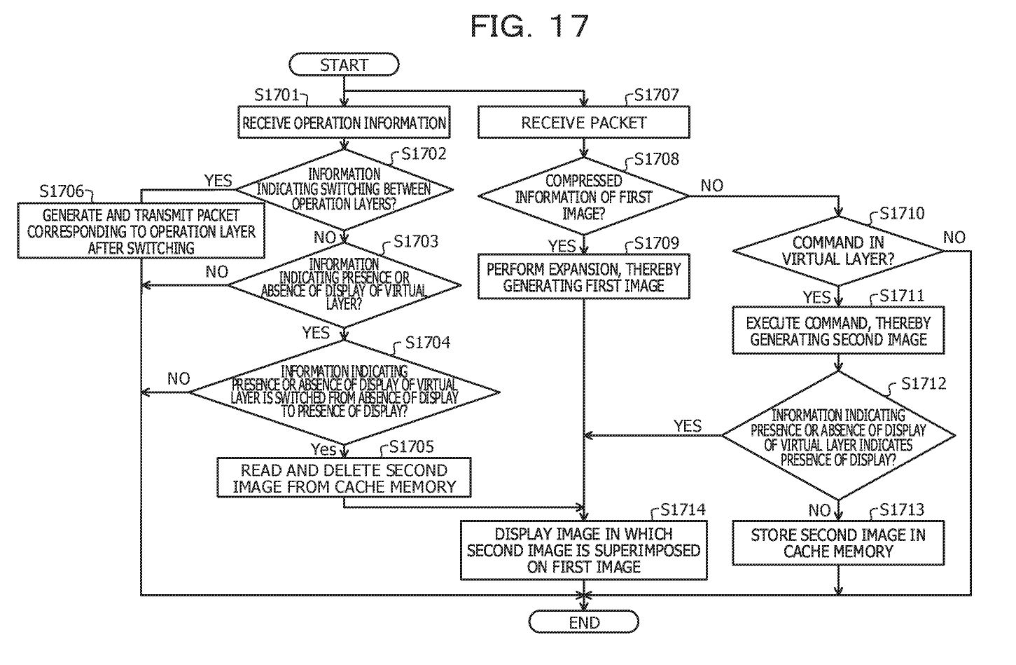

FIG. 17 is a flowchart illustrating an example of a processing procedure performed by a client terminal device according to the first embodiment. First, the corresponding client terminal device 102 receives operation information (step S1701). In addition, the corresponding client terminal device 102 determines whether or not the operation information from an input device such as the mouse 708 or the keyboard 707 is information indicating switching between operation layers (step S1702).

In a case where it is determined that the operation information is not information indicating switching between operation layers (step S1702: No), the corresponding client terminal device 102 determines whether or not the operation information is information indicating the presence or absence of display of the virtual layer (step S1703).

In a case where it is determined that the operation information is not information indicating the presence or absence of display of the virtual layer (step S1703: No), the corresponding client terminal device 102 terminates a series of processing operations. In a case where it is determined that the operation information is information indicating the presence or absence of display of the virtual layer (step S1703: Yes), the corresponding client terminal device 102 determines whether or not the information indicating the presence or absence of display of the virtual layer is switched from indicating the absence thereof to indicating the presence thereof (step S1704). Here, in a case of “Yes” in step S1703, the information indicating the presence or absence of display of the virtual layer is stored, as the latest information, in a storage device.

In a case where it is determined that the information indicating the presence or absence of display of the virtual layer is not switched from indicating the absence thereof to indicating the presence thereof (step S1704: No), the corresponding client terminal device 102 terminates a series of processing operations. On the other hand, in a case where it is determined that the information indicating the presence or absence of display of the virtual layer is switched from indicating the absence thereof to indicating the presence thereof (step S1704: Yes), the corresponding client terminal device 102 reads the second image 121 from the cache memory 820, thereby deleting the second image 121 from the cache memory 820, (step S1705) and makes a transition to step S1714.

In addition, in a case where, in step S1702, it is determined that the operation information is information indicating switching between operation layers (step S1702: Yes), the corresponding client terminal device 102 generates and transmits a packet corresponding to the operation layer after the switching (step S1706) and terminates a series of processing operations.

In addition, the corresponding client terminal device 102 receives a packet (step S1707). In addition, the corresponding client terminal device 102 determines whether or not information included in the received packet is compressed information of the first image 120 (step S1708). In a case where it is determined that the information is the compressed information of the first image 120 (step S1708: Yes), the corresponding client terminal device 102 performs expansion, thereby generating the first image 120, (step S1709) and makes a transition to step S1714.

In a case where, in step S1708, it is determined that the information is not the compressed information of the first image 120 (step S1708: No), the corresponding client terminal device 102 determines whether or not being a command in the virtual layer (step S1710). In a case of being determined as not being a command in the virtual layer (step S1710: No), the corresponding client terminal device 102 terminates a series of processing operations.

On the other hand, in a case of being determined as being a command in the virtual layer (step S1710: Yes), the corresponding client terminal device 102 executes the command, thereby generating the second image 121 (step S1711). In addition, the corresponding client terminal device 102 determines whether or not the last received information indicating the presence or absence of display of the virtual layer indicates the presence of display thereof (step S1712).

In a case where it is determined that the last received information indicating the presence or absence of display of the virtual layer indicates the presence of display thereof (step S1712: Yes), the corresponding client terminal device 102 displays an image in which the second image 121 is superimposed on the first image 120 (step S1714). In a case where it is determined that the last received information indicating the presence or absence of display of the virtual layer does not indicate the presence of display thereof (step S1712: No), the corresponding client terminal device 102 stores the second image 121 in the cache memory 820 (step S1713) and terminates a series of processing operations.

### Second Embodiment

In a second embodiment, the second image 121 including information generated based on a character string obtained from the first image 120 of a screen is displayed while being superimposed on the first image 120 of the screen. From this, it is possible for a user to effectively perform an operation of the screen. In addition, in the second embodiment, a detailed description of the same operation or information as that in the first embodiment will be omitted.

The first generation unit 802 captures a screen obtained by execution of an application. In addition, the first generation unit 802 generates and compresses the image information 111 including the first image 120 of the screen captured by the first generation unit 802. In addition, in such a manner as in the related art illustrated in FIG. 4, the first generation unit 802 may separate a moving image and a still image from each other. The transmission unit 804 transmits the image information 111 including the first image 120.

The second generation unit 803 generates a drawing command that instructs to generate the second image 121 including the information generated based on the character string obtained from the first image 120 of the screen. Specifically, using the OCR, the second generation unit 803 recognizes characters from, for example, the first image 120 of the screen captured by the first generation unit 802. For each of the recognized characters, the second generation unit 803 matches words, based on the dictionary DB 805. In addition, the second generation unit 803 generates a command capable of generating image information indicating an image according to a content corresponding to a character that is registered in the dictionary DB 805 and that is included in the recognized characters. The dictionary DB 805 is realized by the ROM 702, the RAM 703, or the like. In the dictionary DB 805, for each of English words, a Japanese word or the like, which corresponds to, for example, the relevant English, is registered. Alternatively, in the dictionary DB 805, for each of words, a text indicating the meaning of, for example, the relevant word is registered. Alternatively, in the dictionary DB 805, for each of words of Chinese characters, a word indicating Japanese syllabary characters of, for example, the relevant word is registered.

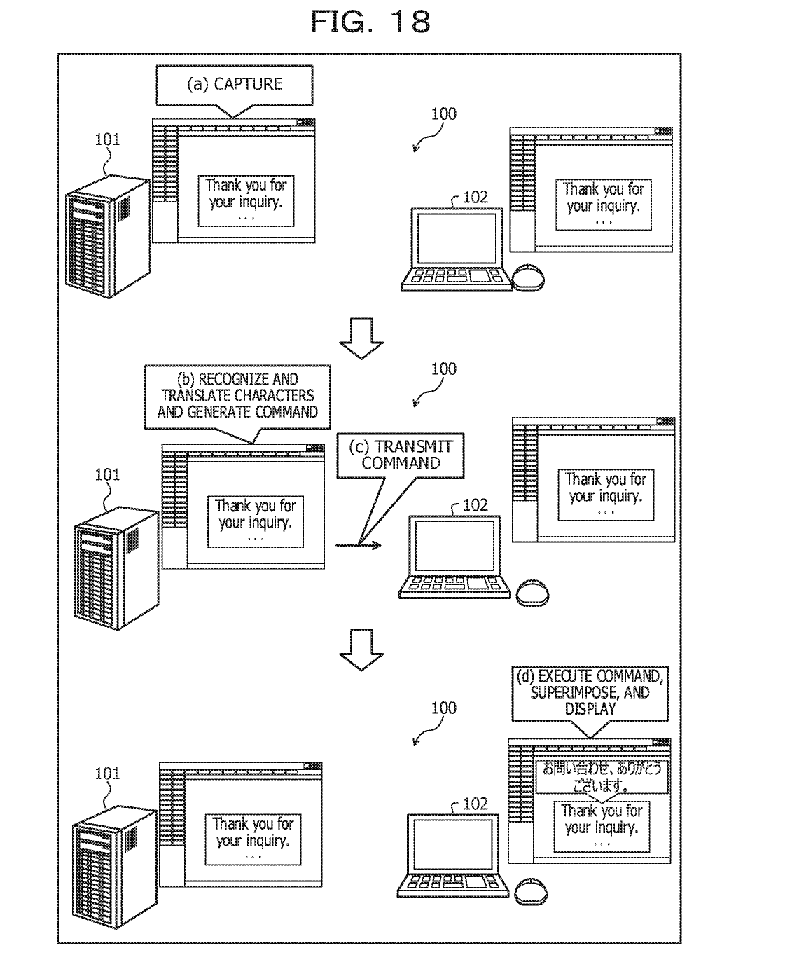

FIG. 18 is an explanatory diagram illustrating an example of an operation of a remote screen display system in the second embodiment. As illustrated in (a) FIG. 18, the server 101 performs capturing of a screen. As illustrated in (b) FIG. 18, using the OCR, the server 101 recognizes characters from the first image 120 of the screen. In addition, the server 101 translates the recognized characters. Regarding a translation method, the translation may be performed based on the dictionary DB 805 as described above, and the translation may be performed by using an existing translation application. The server 101 generates a command capable of generating the second image 121 including a translated character string. The second image 121 including the translated character string may be an image in which a character string is included in, for example, a word balloon and which is obtained by converting, into a display format, information indicating, for example, that the word balloon is located above the recognized characters, and the second image 121 is not specifically limited. As illustrated in (c) in FIG. 18, the server 101 transmits the generated command.

As illustrated in (d) in FIG. 18, the corresponding client terminal device 102 executes the command, thereby generating the second image 121. In addition, the corresponding client terminal device 102 displays an image in which the second image 121 is superimposed on the first image 120.

Example of Processing Procedure Performed by Server 101 According to Second Embodiment

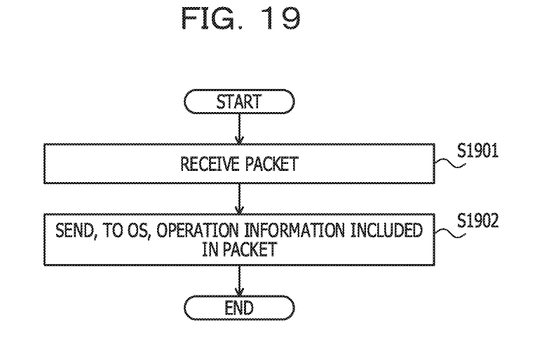

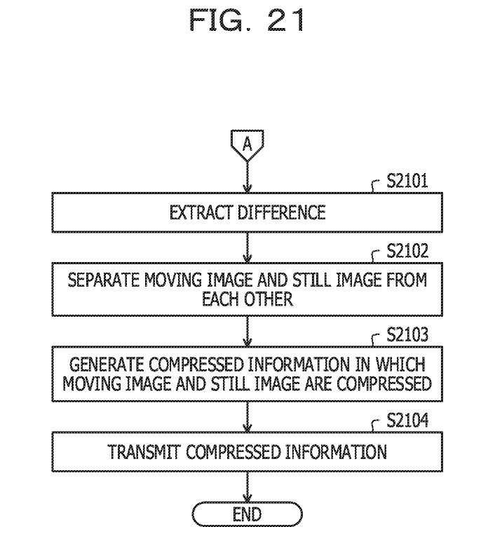

FIG. 19 to FIG. 21 are flowcharts each illustrating an example of a processing procedure performed by a server according to the second embodiment. While, here, the first image 120 is transmitted after transmitting the command capable of generating the second image 121, there is no limitation to this. The command capable of generating the second image 121 may be transmitted after transmitting the first image 120.

First, the server 101 receives a packet (step S1901). In addition, the server 101 sends, to the OS, the operation information included in the packet (step S1902) and terminates a series of processing operations.

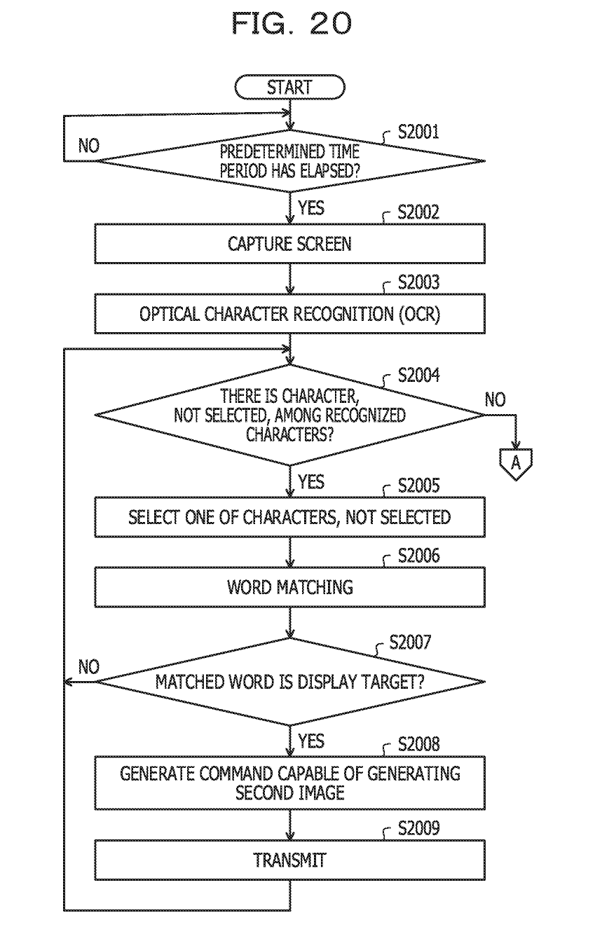

Next, proceeding to the description of FIG. 20, the server 101 determines whether or not a predetermined time period has elapsed (step S2001). In a case where it is determined that the predetermined time period has not elapsed (step S2001: No), the server 101 returns to step S2001. In a case where it is determined that the predetermined time period has elapsed (step S2001: Yes), the server 101 captures a screen (step S2002).

Next, the server 101 performs the OCR (step S2003). The server 101 determines whether or not there is a character, not selected, among recognized characters (step S2004). In a case where it is determined that there is a character, not selected (step S2004: Yes), the server 101 selects one of characters, not selected (step S2005). The server 101 matches a word for the selected character (step S2006).

The server 101 determines whether or not the matched word is a display target (step S2007). In a case where it is determined that the matched word is a display target (step S2007: Yes), the server 101 generates a command capable of generating the second image 121 (step S2008). The server 101 transmits the generated command (step S2009) and returns to step S2004. On the other hand, in a case where, in step S2007, it is determined that the matched word is not a display target (step S2007: No), the server 101 returns to step S2004.

In case where, in step S2004, it is determined that there is no character, not selected, among the recognized characters (step S2004: No), the server 101 extracts a difference (step S2101). The server 101 separates a moving image and a still image from each other (step S2102). The server 101 generates compressed information in which the moving image and the still image are compressed (step S2103). In addition, the server 101 transmits the compressed information (step S2104) and terminates a series of processing operations.

Example of Processing Procedure Performed by Client Terminal Device 102 According to Second Embodiment

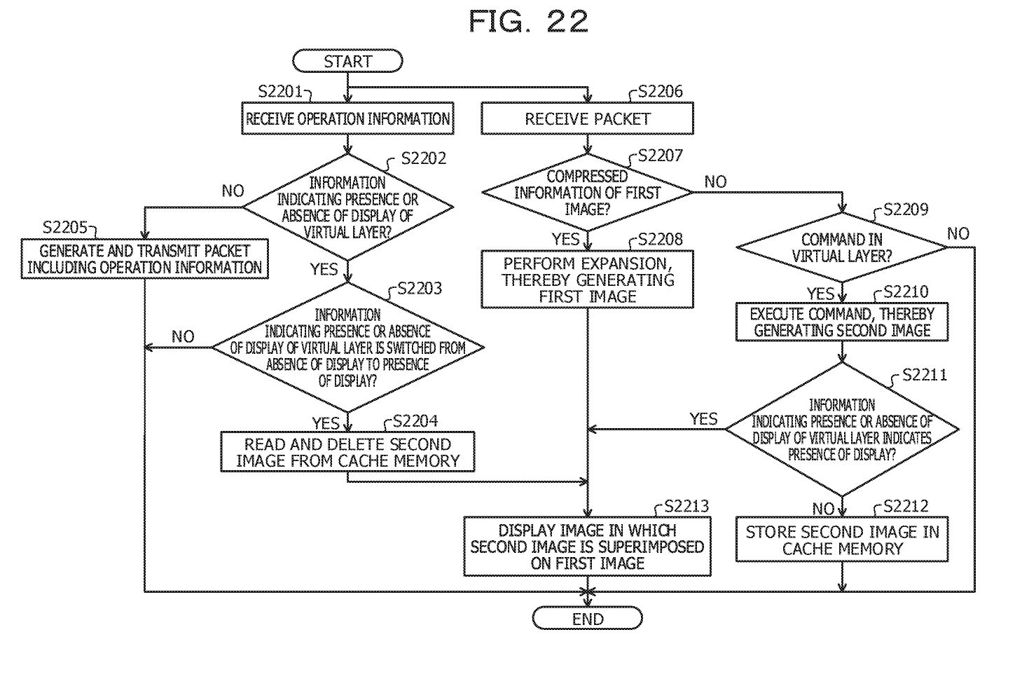

FIG. 22 is a flowchart illustrating an example of a processing procedure performed by a client terminal device according to the second embodiment. First, the corresponding client terminal device 102 receives operation information (step S2201). In addition, the corresponding client terminal device 102 determines whether or not the operation information is information indicating the presence or absence of display of the virtual layer (step S2202).

In a case where it is determined that the operation information is not information indicating the presence or absence of display of the virtual layer (step S2202: No), the corresponding client terminal device 102 generates and transmits a packet, which is a packet corresponding to the operation layer and which includes operation information, (step S2205) and terminates a series of processing operations. In a case where it is determined that the operation information is information indicating the presence or absence of display of the virtual layer (step S2202: Yes), the corresponding client terminal device 102 determines whether or not the information indicating the presence or absence of display of the virtual layer is switched from indicating the absence thereof to indicating the presence thereof (step S2203). Here, in a case of “Yes” in step S2202, the information indicating the presence or absence of display of the virtual layer is stored, as the latest information, in a storage device.

In a case where it is determined that the information indicating the presence or absence of display of the virtual layer is not switched from indicating the absence thereof to indicating the presence thereof (step S2203: No), the corresponding client terminal device 102 terminates a series of processing operations. On the other hand, in a case where it is determined that the information indicating the presence or absence of display of the virtual layer is switched from indicating the absence thereof to indicating the presence thereof (step S2203: Yes), the corresponding client terminal device 102 reads the second image 121 from the cache memory 820, thereby deleting the second image 121 from the cache memory 820, (step S2204) and makes a transition to step S2213.

In addition, the corresponding client terminal device 102 receives a packet (step S2206). In addition, the corresponding client terminal device 102 determines whether or not information included in the received packet is compressed information of the first image 120 (step S2207). In a case where it is determined that the information is the compressed information of the first image 120 (step S2207: Yes), the corresponding client terminal device 102 performs expansion, thereby generating the first image 120, (step S2208) and makes a transition to step S2213.

In a case where, in step S2207, it is determined that the information is not the compressed information of the first image 120 (step S2207: No), the corresponding client terminal device 102 determines whether or not being a command in the virtual layer (step S2209). In a case of being determined as not being a command in the virtual layer (step S2209: No), the corresponding client terminal device 102 terminates a series of processing operations.

On the other hand, in a case of being determined as being a command in the virtual layer (step S2209: Yes), the corresponding client terminal device 102 executes the command, thereby generating the second image 121 (step S2210). In addition, the corresponding client terminal device 102 determines whether or not the last received information indicating the presence or absence of display of the virtual layer indicates the presence of display thereof (step S2211).

In a case where it is determined that the last received information indicating the presence or absence of display of the virtual layer indicates the presence of display thereof (step S2211: Yes), the corresponding client terminal device 102 displays an image in which the second image 121 is superimposed on the first image 120 (step S2213). In a case where it is determined that the last received information indicating the presence or absence of display of the virtual layer does not indicate the presence of display thereof (step S2211: No), the corresponding client terminal device 102 stores the second image 121 in the cache memory 820 (step S2212) and terminates a series of processing operations.

As described above, the server 101 transmits, to the corresponding client terminal device 102, a command for generating the second image 121 related to the first image 120 of a display screen corresponding to execution of an application. In addition, the corresponding client terminal device 100 displays the second image 121 generated by execution of the relevant received command while superimposing the second image 121 on the relevant first image 120. It is possible to cause one of the client terminal devices 102 to swiftly display the second image 121, which corresponds to an operation received by, for example, another one of the client terminal devices 102. From this, it is possible for users to exchange communication related to an image of a screen, not via other devices such as telephone sets. In addition, it is possible to perform exchanges between the server 101 and the corresponding client terminal device 102 with a small data amount. Therefore, in a case of performing the relevant communication by using telephone sets or the like together, it is possible to smoothly perform the relevant communication. Accordingly, it is possible for users of the client terminal devices to efficiently develop works on screens.

In addition, the client terminal devices 102 each enable the presence or absence of display of an image to be switched, the image being related to an image of a display screen. In a case where there are, for example, a large number of users, in response to requests of the respective users, it is possible to switch between display of an image related to an image of the relevant display screen and non-display thereof. Therefore, it is possible to improve convenience.

In addition, in a case where the information indicating the presence or absence of display of the second image 121 related to the first image 120 of the display screen indicates the absence thereof, the client terminal devices 102 each store the second image 121 in the cache memory 820. In addition, in a case where the information indicating the presence or absence of display is switched from the absence thereof to the presence thereof, the client terminal devices 102 each display the second image 121 stored in the cache memory 820 while superimposing the second image 121 on the first image 120. From this, it is possible to easily switch the presence or absence of display, and it is possible to view the latest second image 121. Therefore, it is possible to improve convenience.

In addition, the second image 121 is an image corresponding to an operation performed in one of the client terminal devices 102. The operation performed in one of the client terminal devices 102 indicates, for example, that a user operates the relevant client terminal device 102 in response to the first image 120. The image corresponding to an operation is an image including information obtained by an operation. The information obtained by an operation is, for example, input information of a line, a graphic, a character, and so forth. The image including the information obtained by an operation is, for example, an image in which the information obtained by an operation is converted into a display format. From this, it is possible to improve efficiency in a collaboration work based on users.

In addition, the second image 121 is an image according to design related to the first image 120. As the design, design or the like utilizing, for example, the CAD or the like may be cited. The image according to the design is, for example, an image in which an article, which serves as a design target and which is arranged in a simulation space set on a computer, is converted into a display format. From this, it is possible to improve efficiency in a design work.

In addition, to generate a drawing command, the corresponding client terminal device 102 generates a drawing command that instructs to generate the second image 121 including information generated based on a character string obtained from the first image 120 of a screen. The information generated based on the character string obtained from the first image 120 of a screen may be a text obtained by translating the character string obtained from, for example, the first image 120 of a screen or may be the detailed meaning of a word. From this, it is possible to easily add information to a currently displayed execution result of an application, and it is possible to improve convenience.

Note that a preliminarily prepared remote screen display program is executed by a computer such as the server 101 or the corresponding client terminal device 102, thereby enabling the remote screen display method described in the present embodiment to be realized. The present remote screen display program is recorded in a computer-readable recording medium such as a magnetic disk, an optical disk, or a universal serial bus (USB) flash memory and is read from the recording medium by the computer, thereby being executed. In addition, the remote screen display program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A remote screen display system comprising:
a server apparatus; and
a plurality of client terminal apparatuses coupled to the server apparatus respectively, wherein
the server apparatus includes a processor configured to:
transmit a first screen image to each of the plurality of client terminal apparatuses, the first screen image being updated according to processing of a program on the server apparatus; and
transmit, when receiving information indicating that an operation for a second screen image has been detected on one of the plurality of client terminal apparatuses, a command to make execute the detected operation to each of other terminal apparatuses different from the one of the plurality of client terminal apparatuses; and wherein
each of the plurality of client terminal apparatuses includes a processor configured to:
display the first screen image received from the server apparatus;
generate, or update a second screen image based on the command when receiving the command from the server apparatus;
display the second screen image that is superimposed on the first screen image; and
execute, when detecting the operation for the second screen image, the operation for the second screen image.

2. The remote screen display system according to claim 1, wherein
each of the plurality of client terminal apparatuses is configured to:
receive presence information that indicates the presence or absence of display of the second screen image, based on an operation performed on input apparatuses included by each of the plurality of client terminal apparatuses; and
display the first screen image without superimposing the second screen image in when the information indicates the absence of the display, and display the first screen image and the second screen image superimposed on the first screen image when the presence information indicates the presence of the display.

3. The remote screen display system according to claim 2, wherein
each of the plurality of client terminal apparatuses includes a memory; and wherein
the processor included in each of the plurality of client terminal apparatuses is configured to:
store the second screen image in the memory when the newly received presence information indicates the absence of the display;
display the second image stored in the memory when the newly received presence information indicating is switched from the absence of the display to the presence of the display; and
delete the second screen image from the memory in response to displaying the second screen image.

4. The remote screen display system according to claim 1, wherein
the second screen image is an image corresponding to an operation performed in one of the client terminal apparatuses.

5. The remote screen display system according to claim 1, wherein
the second screen image is an image corresponding to a design related to the first screen image.

6. The remote screen display system according to claim 1, wherein
the second screen image is generated based on a character string obtained from the first screen image.

7. The remote screen display system according to claim 1, wherein
the second screen image includes only one or more objects that are generable based on the command, the one or more objects being line, figure or character.

8. A remote screen display method executed by a server apparatus and a plurality of client terminal apparatuses, the method comprising:
transmitting, by the server apparatus, a first screen image to each of the plurality of client terminal apparatuses, the first screen image being updated according to processing of a program on the server apparatus; and
transmitting, by the server apparatus, when receiving information indicating that an operation for a second screen image has been detected on one of the plurality of client terminal apparatuses, a command to make execute the detected operation to each of other terminal apparatuses different from the one of the plurality of client terminal apparatuses;
generating or updating, by each of the plurality of client terminal apparatuses, the second screen image based on the command when receiving the command from the server apparatus;
displaying, by each of the plurality of client terminal apparatuses, the second screen image that is superimposed on the first screen image; and
executing, by each of the plurality of client terminal apparatuses, the operation for the second screen image when detecting the operation for the second screen image.

9. A non-transitory computer-readable recording medium storing a remote screen display program that causes a server apparatus to execute a process, the server coupled to a plurality of client terminal apparatuses, the process comprising:
transmitting a first screen image to each of the plurality of client terminal apparatuses, the first screen image being updated according to processing of a program on the server apparatus; and
transmitting, when receiving information indicating that an operation for a second screen image has been detected on one of the plurality of client terminal apparatuses, a command to make execute the detected operation to each of other terminal apparatuses different from the one of the plurality of client terminal apparatuses, the second screen image being displayed on each of other terminal apparatuses with superimposing on the first screen image;
